(19) United States
(12) Patent Application Publication
(10) Pub. No.: US 2018/0353374 A1
(43) Pub. Date: Dec. 13, 2018

(54) ELECTRIC MASSAGING BED

(71) Applicant: Chuan-Hang SHIH, Lu-Kang Town (TW)

(72) Inventor: Chuan-Hang SHIH, Lu-Kang Town (TW)

(21) Appl. No.: 15/703,244

(22) Filed: Sep. 13, 2017

(30) Foreign Application Priority Data
Jun. 13, 2017 (TW) 106208556

(51) Int. Cl. A61H 23/02; A47C 19/02

(52) U.S. Cl. CPC A61H 23/02; A47C 19/025; A61H 2203/0456; A61H 2201/0142; A61H 2205/086; A61H 2205/10; A61H 2205/081

(57) ABSTRACT

An electric massaging bed includes a bed frame, a cover member, a vibration motor, and a support member. The bed frame has a frame body provided with a top surface, a bottom surface and a hollow portion penetrating through the frame body. The cover member accommodated in the hollow portion, the cover member is made of a shock-absorbing material and has a top surface substantially flush with the top surface of the frame body and an accommodation groove recessed on the top surface of the cover member. The vibration motor disposed in the accommodation groove. The support member mounted to the bottom surface of the frame body and abutted against a bottom surface of the cover member to support the cover member. Therefore, the vibration generated by the vibration motor can directly transmits to users so that the users can directly feel the concentrated effect of vibrating massage.

### BACKGROUND OF THE INVENTION

### 1. Field of the Invention The present invention relates generally to a massage apparatus and more particularly, to an electric massaging bed.

### 2. Description of the Related Art

Conventional electric massaging bed are known having a bone rack, at least one fixed plate which is disposed to the bone rack and having a bottom surface and a top surface, and one or more than one vibration motor which is mounted to the bottom surface of the fixed plate. A user who lies on a mattress which is placed on the top surface of the fixed plate could obtains the effect of the electric massaging bed when a vibration resulted from the vibration motor via the fixed plate transmits to the mattress.

However, in the above-mentioned conventional design, the vibration generated by the vibration motor is easily transmitting to other locations of the mattress via the fixed plate. For users, they cannot get the most directly, and the most concentrated massage effect, and they also feel uncomfortable when the vibration transmits to some parts of the body that they don't want to be massaged. Even the fixed plate and the bone rack would be shook together in the process of transmission of the vibration, in this way the vibration motor would easily loose from the fixed plate during the constant vibration process, the bolts mounted on the fixed plate or the bone rack also easily loose to affect the stability of the bed frame structure, even more in the worse situation the bed frame may disintegrate so the user's personal safety would at risk.

Therefore, manufacturers developed a new installation method of vibration motor which is disposing a shock-absorbing material between the vibration motor and the fixed plate. However, so far this kind of the installation method of vibration motor involves complex structures, thus it makes the installation step complicate, consumes time, and enhances installation costs.

### SUMMARY OF THE INVENTION

The present invention has been accomplished in view of the above-noted circumstances. It is an objective of the present invention to provide an electric massaging bed which supplies concentrated vibration range, so the structure of the electric massaging bed is stable, users can feel more comfortable while they use the electric massaging bed, further, the electric massaging bed can be easily, quickly assembled and the cost of the electric massaging bed is low.

To attain the above objective, the present invention provides an electric massaging bed, which comprises a bed frame, a cover member, a vibration motor, and a support member. The bed frame has a frame body that is provided with a top surface, a bottom surface and a hollow portion penetrating through the top surface and the bottom surface. The cover member has a part accommodated in the hollow portion of the frame body, a top surface and an accommodation groove recessed on the top surface of the cover member, the cover member is made of a shock-absorbing material. The vibration motor disposed in the accommodation groove of the cover member. The support member mounted to the bottom surface of the frame body and abutted against a bottom surface of the cover member to support the cover member.

Due to the top surface of the vibration motor is not covered by the cover member, the vibration generated by the vibration motor can directly transmits from the top surface of the vibration motor to the body of users so that the users can directly feel the concentrated effect of vibrating massage. Because the place outside the top surface of the vibration motor is covered by the cover member, the vibration transmits from the place outside the top surface of the vibration motor to out will be absorbed by the cover member. As such, the bed frame will not produces extra vibrations, users can feel more comfortable while they use the electric massaging bed, and the structure of the electric massaging bed is stable. Further, the electric massaging bed can be easily, quickly assembled and the cost of the electric massaging bed is lower than the conventional electric massaging bed.

Further scope of applicability of the present disclosure will become apparent from the detailed description given hereinafter. However, it should be understood that the detailed description and specific examples, while indicating preferred embodiments of the invention, are given by way of illustration only, since various changes and modifications within the spirit and scope of the invention will become apparent to those skilled in the art from this detailed description.

### BRIEF DESCRIPTION OF THE DRAWINGS

The present invention will become more fully understood from the detailed description given herein below and the accompanying drawings which are given by way of illustration only, and thus are not limitative of the present invention, and wherein:

FIG. 1 is a top perspective view of an electric massaging bed according to a preferred embodiment of the present invention;

FIGS. 2 is a bottom perspective view of the electric massaging bed according to the preferred embodiment of the present invention;

FIG. 3 is a partial perspective exploded view of the electric massaging bed according to the preferred embodiment of the present invention; FIG. 4 is a partial perspective exploded view of a cover member and a vibration motor according to the preferred embodiment of the present invention; and

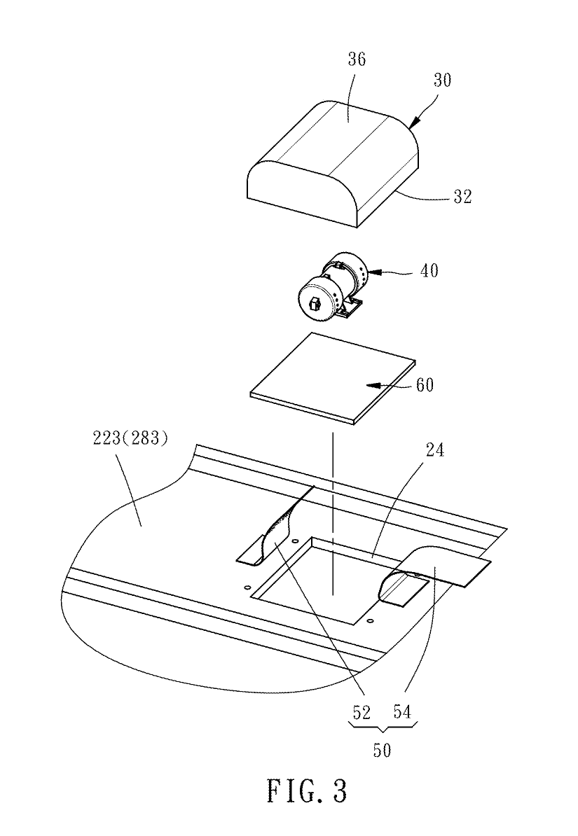

FIG. 5 is an enlarged partial cutaway lateral plan view of the electric massaging bed according to the preferred embodiment of the present invention.

### DETAILED DESCRIPTION OF THE INVENTION

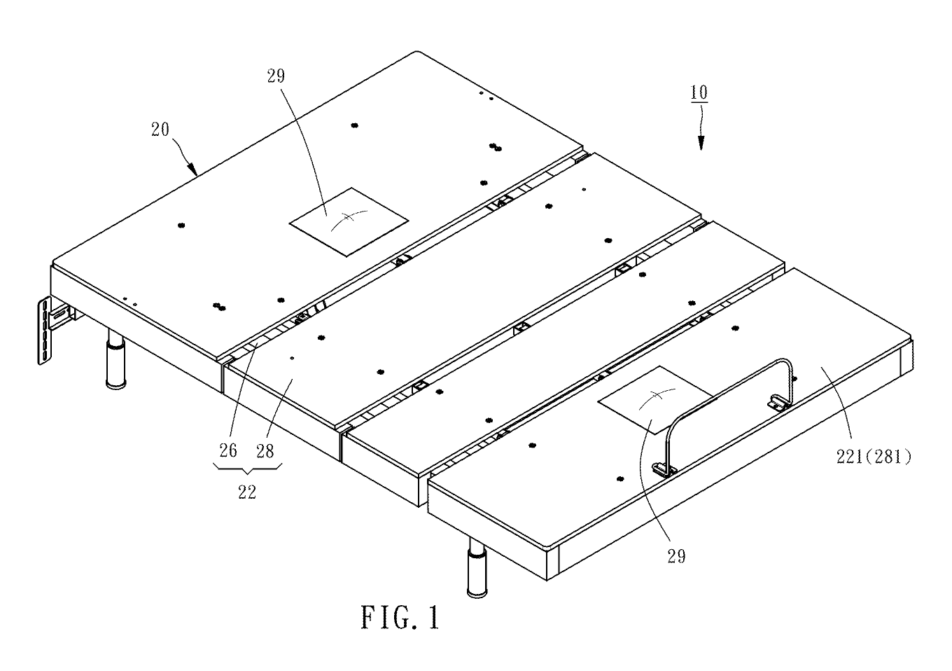

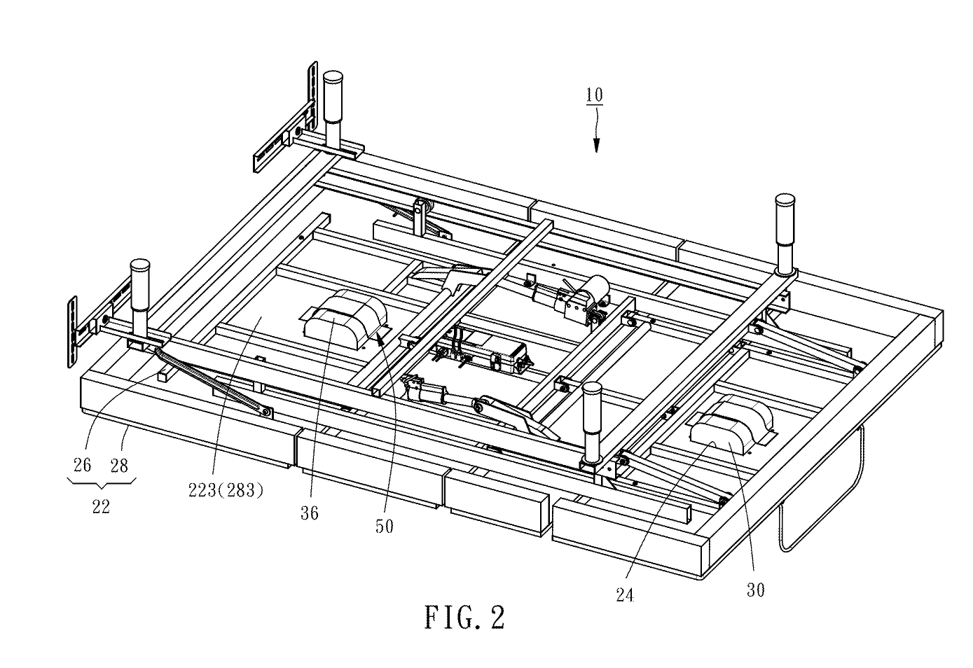

Referring to FIGS. 1 and 2, an electric massaging bed 10 provided by a preferred embodiment of the present disclosure, the electric massaging bed 10 is composed of a bed frame 20, a cover member 30, a vibration motor 40, a support member 50 and a cushion pad 60.

The bed frame 20 has a frame body 22 that is provided with a top surface 221, a bottom surface 223 and two hollow portions 24 penetrating through the top surface 221 and the bottom surface 223. In this embodiment, the frame body 22 of the bed frame 20 comprises a bone rack 26 and four bed plates 28 which is made of a wood material mounted on the bone rack 26. The two hollow portions 24 are disposed to two of the bed plates 28 respectively, which means the two hollow portions 24 are penetrate through the bed plates 28. The bed frame 20 further comprises two fabrics 29 that is mounted to the frame body 22 of the bed frame 20 and cover the two hollow portions 24 of the frame body 22, respectively. In more detail, the two fabrics 29 are mounted on the two bed plates 28, in another embodiment, the manner that the two fabrics 29 are mounted on the two bed plates 28 is not limited, for example, the two fabrics 29 may be secured to the bed plates 28 by means of nails and sticks. In another embodiment, the structure of the frame body 22 may be different from the one disclosed in this embodiment, such as the frame body 22 is integrated, or the bed plates 28 is made by the iron network and the hollow portion 24 is located between the iron net.

The cover member 30 has a part accommodated in the hollow portion 24 of the frame body 22, a top surface 32, a bottom surface 36 and an accommodation groove 34 recessed on the top surface 32 of the cover member 30, the cover member 30 is made of a shock-absorbing material, particularly foam material is better, such as foam. When the top portion of the cover member 30 accommodated in the hollow portion 24, the cover member 30 has a periphery abutted against a wall of the hollow portion 24. The cover member 30 may be in an uncompressed state or a compressed state, i.e. the size of the cross section of the cover member 30 is substantially equivalent to the size of the hollow portion 24 or larger than the hollow portion 24. In another embodiment, the size of the cross section of the cover member 30 can smaller than the hollow portion 24, and the material of the cover member 30 is not limited to the foam, as long as the material has the shock-absorbing function which is applicable to the cover member 30.

The vibration motor 40 is disposed in the accommodation groove 34 of the cover member 30, the vibration motor 40 has a top surface 42 that substantially flush with the top surface 221 of the frame body 22 i.e. the top surface 281 of the bed plate 28. In this embodiment, the top surface 42 of the vibration motor 40 protrudes over the top surface 32 of the cover member 30. In another embodiment, the top surface 42 of the vibration motor 40 can protrudes over the top surface 221 of the frame body 22 i.e. the top surface 281 of the bed plate 28.

The support member 50 is mounted to the bottom surface 223 of the frame body 22 i.e. the bottom surface 283 of the bed plate 28, the support member 50 abutted against the bottom surface 36 of the cover member 30 to support the cover member 30. In this embodiment, the support member 50 is a hook and loop fastener including a male fastening member 52 having an end fixedly nailed or stuck to the bottom surface 223 of the frame body 22, and a female fastening member 54 having an end fixedly nailed or stuck to the bottom surface 223 of the frame body 22 i.e. the bottom surface 283 of the bed plate 28, another end of the male fastening member 52 and another end of the female fastening member 54 can stick together with each other to abutted against the bottom surface 36 of the cover member 30 to support the cover member 30, in such a case, even the size of the cover member 30 is smaller than the hollow portion 24 so that the periphery of the cover member 30 does not abutted against the wall of the hollow portion 24, the support member 50 can also supports the cover member 30 to avoid the cover member 30 falling. In another embodiment, the support member 50 is replaced by a tape or a rope or other support member which can supports the cover member 30. In another embodiment, the number of the support member 50 varies depending on the demand, for example, the support member 50 can be replaced by more than one plastic sheet or more than one rubber band to supports the cover member 30. In another embodiment, the manner that the support member 50 mounting to the frame body 22 may has other variations, for example, the bottom surface 223 of the frame body 22 may be provided with a plurality of hooks which are adjacent to the hollow portion 24, and the support member 50 is provided with a plurality of holes for the hooks to be fixed.

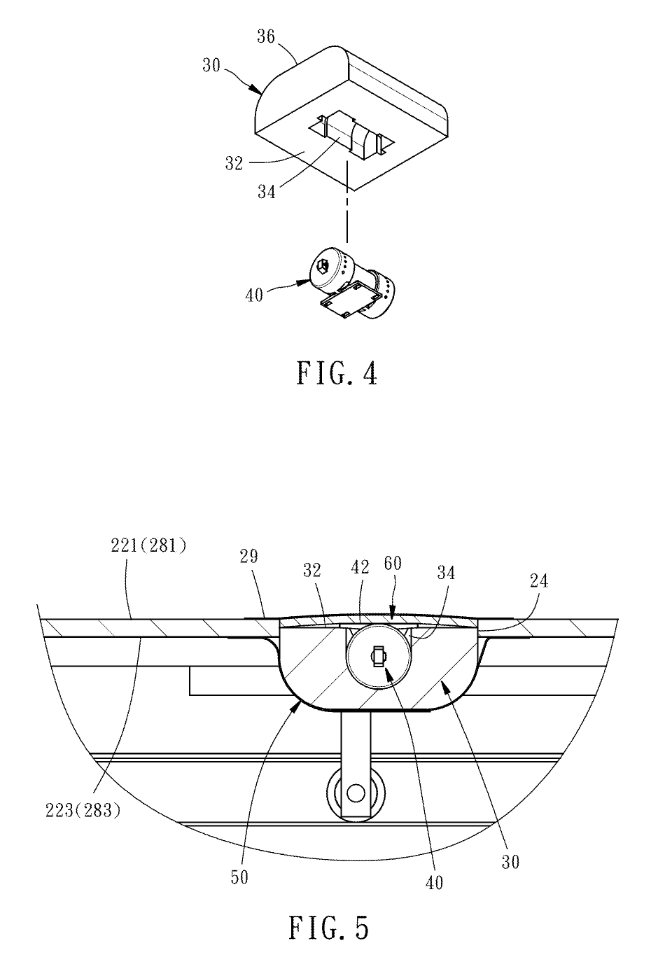

As shown in FIGS. 5, the cushion pad 60 is mounted on a top surface 42 of the vibration motor 40 and is located in the hollow portion 24, a top edge of the cushion pad 60 is abutted against a bottom edge of the fabrics 29, the cushion pad 60 is made of a shock-absorbing material, so the cushion pad 60 slightly mitigates the vibration which is resulted from the vibration motor 40 upwardly transmitting to the human body so that the human body will not feel uncomfortable due to the too strong vibration. In another embodiment, the cushion pad 60 can be omitted.

When the electric massaging bed 10 is in assembly, the cushion pad 60 could be accommodated in the hollow portion 24 first, and the vibration motor 40 is placed in the accommodation groove 34 of the cover member 30, the cover member 30 is placed in the hollow portion 24 and the top surface 32 is facing to the cushion pad 60, and then the male fastening member 52 and the female fastening member 54 stick together with each other and also abuts against the bottom surface 36 of the cover member 30, such that the cover member 30 will not falls down. The cover member 30, the male fastening member 52 and the female fastening member 54 are very inexpensive with the components, so the electric massaging bed 10 can be quickly assembled and the cost of the electric massaging bed 10 is lower than the conventional electric massaging bed. Actually, it will be appreciated that the way of assembling the electric massaging bed 10 is not limited to the way disclosed in this embodiment. After the electric massaging bed 10 is assembled, the users can lie down on the top surface 221 of the frame body 22 directly or put a mattress on the top surface 221 of the frame body 22 then lie down on the mattress, the vibration generated by the vibration motor 40 can transmits from the top surface 42 upwardly to the users body or via the mattress that corresponding to the position of the vibration motor 40 transmits to the users body so that the specific body parts of users can feel the concentrated vibration massage effect. Because the place outside the top surface 42 of the vibration motor 40 is covered by the cover member 30, the vibration transmits from the place outside the top surface 42 of the vibration motor 40 to out will be absorbed by the cover member 30. As such, the bed frame 20 will not produces extra vibrations, users can feel more comfortable while they use the electric massaging bed 10, and the structure of the electric massaging bed 10 is stable. Actually, in another embodiment, the hollow portion 24 at the position of the frame body 22 may be different from the one disclosed in this embodiment, therefore the vibration motor 40 corresponds to the position of users could be their back, buttocks or legs or other different parts of the body, even the bed frame 20 may has one or two or more hollow portions 24 for the cover member 30 and the vibration motor 40 accommodated in.

The invention being thus described, it will be obvious that the same may be varied in many ways. Such variations are not to be regarded as a departure from the spirit and scope of the invention, and all such modifications as would be obvious to one skilled in the art are intended to be included within the scope of the following claims.

What is claimed is:

1. An electric massaging bed, comprising:
a bed frame having a frame body that is provided with a top surface, a bottom surface and a hollow portion penetrating through the top surface and the bottom surface;
a cover member having a part accommodated in the hollow portion of the frame body; a top surface, a bottom surface and an accommodation groove recessed on the top surface of the cover member, the cover member being made of a shock-absorbing material;
a vibration motor disposed in the accommodation groove of the cover member; and
a support member mounted to the bottom surface of the frame body and abutting against the bottom surface of the cover member to support the cover member.

2. The electric massaging bed as claimed in claim 1, wherein the frame body of the bed frame comprises a bone rack and a bed plate mounted on the bone rack; the bed plate is provided with said hollow portion.

3. The electric massaging bed as claimed in claim 1, wherein the cover member has a periphery abutted against a wall of the hollow portion.

4. The electric massaging bed as claimed in claim 3, wherein the cover member is made of a foaming material.

5. The electric massaging bed as claimed in claim 1, wherein the vibration motor has a top surface that protrudes over or is flush with the top surface of the frame body.

6. The electric massaging bed as claimed in claim 1, wherein the support member is a hook and loop fastener including a male fastening member having an end fixedly mounted to the bottom surface of the frame body, and a female fastening member having an end fixedly mounted to the bottom surface of the frame body.

7. The electric massaging bed as claimed in claim 1, wherein the support member is a tape or a rope.

8. The electric massaging bed as claimed in claim 1, further comprising a cushion pad mounted on a top surface of the vibration motor.

9. The electric massaging bed as claimed in claim 1, further comprising a fabric that is mounted to the frame body of the bed frame and covers the hollow portion of the frame body.

10. The electric massaging bed as claimed in claim 2, wherein the cover member has a periphery abutted against a wall of the hollow portion.

11. The electric massaging bed as claimed in claim 8, wherein the cover member is made of a foaming material.

12. The electric massaging bed as claimed in claim 2, wherein the vibration motor has a top surface that protrudes over or is flush with the top surface of the frame body.

13. The electric massaging bed as claimed in claim 2, wherein the support member is a hook and loop fastener including a male fastening member having an end fixedly mounted to the bottom surface of the frame body, and a female fastening member having an end fixedly mounted to the bottom surface of the frame body.

14. The electric massaging bed as claimed in claim 2, wherein the support member is a tape or a rope.

15. The electric massaging bed as claimed in claim 2, further comprising a cushion pad mounted on a top surface of the vibration motor.

16. The electric massaging bed as claimed in claim 2, further comprising a fabric that is mounted to the frame body of the bed frame and covers the hollow portion of the frame body.
